(19) United States
(12) Patent Application Publication
(10) Pub. No.: US 2013/0018633 A1
(43) Pub. Date: Jan. 17, 2013

(54) METHOD AND APPARATUS FOR CENTRAL FREQUENCY ESTIMATION

(71) Applicants: Mohsen Amiri Farahani, Fredericton (CA); Eduardo Castillo Guerra, Fredericton (CA); Bruce G. Colpitts, Fredericton (CA); Anthony W. Brown, Fredericton (CA)

(72) Inventors: Mohsen Amiri Farahani, Fredericton (CA); Eduardo Castillo Guerra, Fredericton (CA); Bruce G. Colpitts, Fredericton (CA); Anthony W. Brown, Fredericton (CA)

(73) Assignee: UNIVERSITY OF NEW BRUNSWICK, Fredericton (CA)

(21) Appl. No.: 13/548,138

(22) Filed: Jul. 12, 2012

Related U.S. Application Data
(60) Provisional application No. 61/506,850, filed on Jul. 12, 2011.

(51) Int. Cl. G06F 15/00; G02F 1/01

(52) U.S. Cl. 702/189; 385/1

(57) ABSTRACT

A method and apparatus comprising acquiring spectral measurements from an optical fiber sensor. The optical fiber sensor is an SBS-based sensor such as a BOTDA. The acquired measurements are of Brillouin interactions at a point along the optical fiber being excited by the lasers of the SBS-based sensor. The acquired measurements can comprise discreet measurements of the Brillouin gain spectrum (“BGS”) at the point along the fiber. The discreet measurements can be plotted as data points. A BGS can be defined by three parameters: the Brillouin frequency shift (“BFS”), the bandwidth and the peak gain. A Lorentzian curve can be used to model a BGS. A BFS can be determined by estimating the central frequency of the Lorentzian curve which is used to model the BGS.

### FIELD

The present invention relates to the field of stimulated Brillouin scattering (“SBS”) measurement and apparatus.

### BACKGROUND

Distributed optical fiber sensors based on SBS have been widely used in the last few decades to measure strain and temperature along many kilometres of sensing fiber. SBS sensors have attracted an extensive amount of research because of their ability to work in hazardous environments, their immunity to electromagnetic interference, and their long range distributed sensations.

Brillouin optical time-domain analysis (“BOTDA”) is one of the common configurations for SBS-based distributed sensors. In general terms, in this configuration, a pulsed probe beam and a continuous wave (“CW”) pump beam, at different frequencies, interact through the intercession of an acoustic wave and the power of the CW beam is monitored. In essence, the pulse power of the probe laser is transferred to the CW beam emitted by the pump laser when the frequency difference between the lasers is within the local Brillouin gain spectrum (“BGS”) of the fiber. Based on the foregoing theory, an ideal BGS can be modeled by a Lorentzian distribution in the frequency domain [1], [2].

$$g ( v ) = \frac{{g}_{B}}{1 + 4 {( \frac{v - {v}_{B}}{Δ {v}_{B}} )}^{2}} \qquad ( 1 )$$

Three parameters are required to describe the BGS: the Brillouin frequency shift (“BFS”) ν_{B}, the bandwidth Δν_{B} and the peak gain g_{B} . FIG. 1 shows an ideal BGS along with an illustration of how each parameter in equation (1) is determined. From the standpoint of a sensing system, ν_{B} is the most important spectral parameter as it is linearly depended upon the strain and temperature as:

ν_{B}(T,ε)=C_{T}T+C_{ε}ε+ν_{B}_{₀} (2)

In equation (2), C_{T} is the temperature coefficient in MHz/° C., T is the temperature in ° C., ν_{B}_{₀} is the reference Brillouin frequency in MHz, C_{ε} is the strain coefficient in MHz/με, and ε is the strain in με.

The BFS is easily calculated by finding the frequency of the maximum peak in the ideal spectrum but its calculation is not that straightforward in real measurements. In effect, spectra acquired from measurements in optical fiber sensors do not have a perfect Lorentzian distribution and under some conditions their shape deviates from a Lorentzian to a Gaussian distribution [3]-[5]. Besides an imperfect Lorentzian distribution, the shape of spectra is also deformed by the noise present in optical sensors [6].

In the case of a distorted and noisy spectrum, an ideal Lorentzian curve is fitted to the spectrum and the frequency of the maximum in the fitted curve is taken as the central frequency of the spectrum. Accuracy of the estimated central frequency is directly dependent upon how noisy and deformed the spectrum is.

There are numerous algorithms for fitting a curve of data [7], [8] that can be used to fit a Lorentzian curve to spectra. Curve fitting algorithms are typically divided into two categories: linear and nonlinear. Nonlinear algorithms are more flexible, robust and applicable than linear ones, as they fit a curve into data using more parameters. However, both linear and nonlinear algorithms have been extensively used to fit a Lorentzian curve into spectra in optical fiber sensors. For instance, the central frequency of spectra was estimated using both linear and nonlinear algorithms in [6]. DeMerchant et al. used a nonlinear algorithm to fit a mathematical model based upon the theoretical shape of spectrum in [9]. This method is based on the Levenberg-Marquardt algorithm (LMA), a numerical approach under the criterion of least squared error [10], [11]. In contrast to other nonlinear algorithms such as the Gauss-Newton algorithm, the LMA can find a least squared solution even if it starts far off the final minimum. This characteristic makes it one of the most efficient optimization algorithm that can be used for curve fitting [9], [12]-[14].

Studies and experiments about the applications of nonlinear curve fitting methods to optical sensors demonstrate that the accuracy of results is directly dependent upon the initialization of fitting parameters [12], [14]. They show that initializations too far off the expected fitting parameters yield big errors in results.

### SUMMARY

The BFS, which is the central frequency of a BGS measured from an SBS-based sensor contains strain or temperature information. Therefore, the central frequency of the measured Lorentzian curve will move up or down in frequency according to the changing conditions on the optical fiber associated with the sensor (see equation 2). In one embodiment of the present invention, that central frequency is calculated. A reference Lorentzian curve is cross correlated with a measured Lorentzian curve. Knowing the central frequency of the reference Lorentzian curve, one can calculate the central frequency the measured Lorentzian curve just by finding the frequency of the peak of the curve resulting from cross-correlation.

In another embodiment, the method of the present invention comprises acquiring spectral measurements from an optical fiber sensor. The optical fiber sensor is an SBS-based sensor such as a BOTDA. The acquired measurements are of Brillouin interactions at a point along the optical fiber being excited by the lasers of the SBS-based sensor. The acquired measurements can comprise discreet measurements of the Brillouin gain spectrum (“BGS”) at the point along the fiber. The discreet measurements can be plotted as data points. A BGS can be defined by three parameters: the Brillouin frequency shift (“BFS”), the bandwidth and the peak gain. A Lorentzian curve can be used to model a BGS. A BFS can be determined by estimating the central frequency of the Lorentzian curve which is used to model the BGS. A reference Lorentzian curve with a known BFS is provided. A noisy Lorentzian curve is provided which comprises an ideal Lorentzian curve and noise in the measurements. The reference Lorentzian curve is cross correlated with the noisy Lorentzian curve to yield a third Lorentzian curve which is the product of the cross correlation. The frequency of the maximum (the central frequency) of the third Lorentzian curve is then determined and is used to estimate the central frequency of the noisy Lorentzian curve. This central frequency along with the temperature and strain coefficients of the optical fiber are used to solve for the fiber temperature or strain.

In another embodiment, in the method of the present invention, a Gaussian curve can be substituted for the Lorentzian curve.

In another embodiment, in the method according to the present invention, the central frequency of spectra that are a combination of more than one Lorentzian curve or more than one Gaussian curve are estimated.

In one aspect, the present invention relates to a method of estimating of BFSs independent of the initial fitting parameters using cross correlation.

In another aspect, the present invention relates to finding the central frequency of a noisy Lorentzian curve by using cross correlation to produce a curve with a Lorentzian distribution.

In a further aspect, the present invention relates to determining cross-correlation between an ideal and a noisy Lorentzian curve and using the cross correlation to produce a curve whose shape is mainly determined by the signal, not noise.

In a still further aspect, the present invention relates to a method of determining a Brillouin frequency shift from one or more Brillouin gain measurements in an optical fiber comprising providing an ideal Lorentzian curve with a known Brillouin frequency shift; providing a noisy Lorentzian curve; and cross correlating the ideal Lorentzian curve with the noisy Lorentzian curve wherein the product of the cross correlation is a third Lorentzian curve.

In a still further aspect, the present invention relates to a method of determining a parameter of an optical fiber comprising providing an optical fiber sensor system; providing an optical fiber connected to the optical fiber sensor system; using the optical fiber sensor system to excite a Brillouin interaction at a point along the optical fiber; acquiring one or more discreet measurements of the Brillouin gain spectrum from the interaction, the Brillouin gain spectrum comprising the parameter's Brillouin frequency shift, bandwidth and peak gain; modeling the Brillouin gain spectrum with a Lorentzian curve comprising a central frequency; estimating the central frequency of the Lorentzian curve; providing a reference Lorentzian curve with a known Brillouin frequency shift; providing a noisy Lorentzian curve; cross correlating the reference Lorentzian curve with the noisy Lorentzian curve wherein the product of the cross correlation is a third Lorentzian curve; determining the central frequency of third Lorentzian curve; using the central frequency of third Lorentzian curve to estimate the central frequency of the noisy Lorentzian curve; acquiring a temperature coefficient and a strain coefficient of the optical fiber; and using the estimated central frequency of the noisy Lorentzian curve and the temperature and strain coefficients to determine a parameter of the optical fiber, the parameter selected from the group consisting of temperature and strain.

The methods according to one or more embodiments of the present invention are not limited to estimating a peak position of a Lorentzian curve but can also be used to estimate the peak position of a Gaussian curve, including curves produced by fiber optical sensors.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an ideal prior art BGS;

FIG. 2 are ideal Lorentzian curves and the curve resulting from their cross-correlation;

FIG. 3 is a cross-correlation between an ideal Lorentzian curve and white noise;

FIG. 4 is a cross-correlation between the reference and noisy Lorentzian curves;

FIG. 5 illustrates an error between the estimated and expected central frequencies versus SNR for the LMA and correlation-based methods;

FIG. 6 illustrates a calculated central frequency versus the initial setting of the central frequency parameter for the LMA method;

FIG. 7 illustrates an error between the calculated and expected central frequencies in the LMA for a range of −50 to 50 MHz; inset: error between the calculated and expected central frequencies in the LMA for a range of −20 to 20 MHz;

FIG. 8 illustrates the central frequencies versus changes in the initial setting of bandwidth parameter in both methods;

FIG. 9 illustrates the error between the calculated and expected central frequencies versus the changes in the initial setting of bandwidth parameter in both;

FIG. 10 illustrates a BOTDA system;

FIG. 11 illustrates a noisy spectrum and the expected Lorentzian curve;

FIG. 12 illustrates an error between the estimated and expected central frequencies versus SNR for the LMA and correlation-based methods;

FIG. 13 illustrates an error versus SNR for different central frequency parameters;

FIG. 14 illustrates an error between the estimated and expected central frequencies versus the SNR for different bandwidth parameters;

FIG. 15 is an error between the estimated and expected central frequencies versus the SNR in the LMA and correlation-based method;

FIG. 16 illustrates the central frequency versus the changes in the initial setting of the central frequency in both methods;

FIG. 17 illustrates an error versus the changes in the central frequency parameter in the LMA method;

FIG. 18 illustrates an error versus the changes in the central frequency parameter in the correlation-based method;

FIG. 19 is an illustration of a general purpose computer system; and

FIG. 20 is a schematic diagram of a BOTDA system according to an embodiment of the present invention.

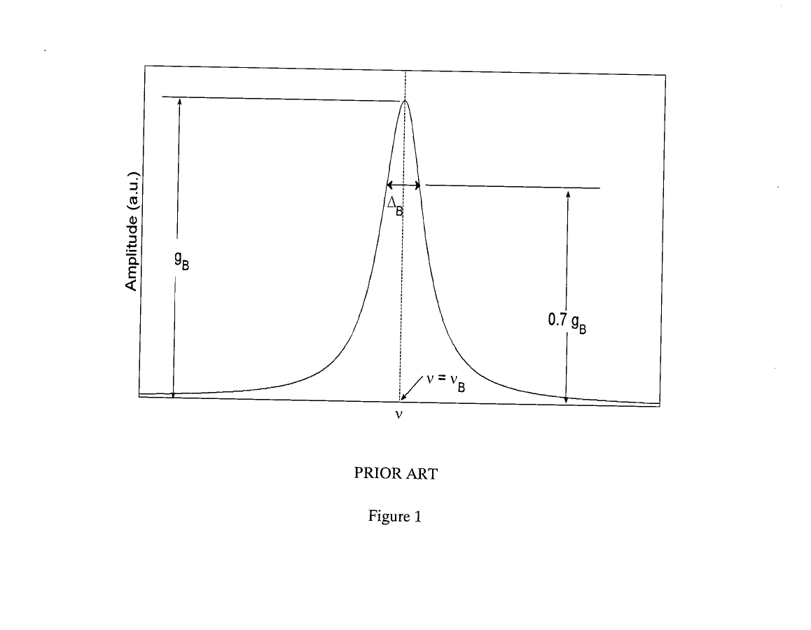

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The cross-correlation between two Lorentzian curves results in a curve with a Lorentzian distribution which can be expressed as follows:

Assuming two Lorentzian curves, gᵣ(ν) and gᵤ(ν), with different peak gains, central frequencies and bandwidths:

$${g}_{r} ( v ) = \frac{{g}_{{B}_{r}}}{1 + 4 {( \frac{v - {v}_{{B}_{r}}}{Δ {v}_{{B}_{r}}} )}^{2}} {g}_{u} ( v ) = \frac{{g}_{{B}_{u}}}{1 + 4 {( \frac{v - {v}_{{B}_{u}}}{Δ {v}_{{B}_{u}}} )}^{2}} \qquad ( 3 )$$

The cross correlation between these two curves results in a curve G_{c}(ν) having a Lorentzian distribution with these specifications:

$${G}_{c} ( v ) = {g}_{r} ( v ) * {g}_{u} ( v ) = \frac{{G}_{c}}{1 + 4 {( \frac{v - {v}_{{B}_{c}}}{Δ {v}_{{B}_{c}}} )}^{2}} \\ {v}_{{B}_{c}} = {v}_{{B}_{r}} + {v}_{{B}_{u}} \& Δ {v}_{{B}_{c}} = Δ {v}_{{B}_{r}} + Δ {v}_{{B}_{u}} \qquad ( 4 )$$

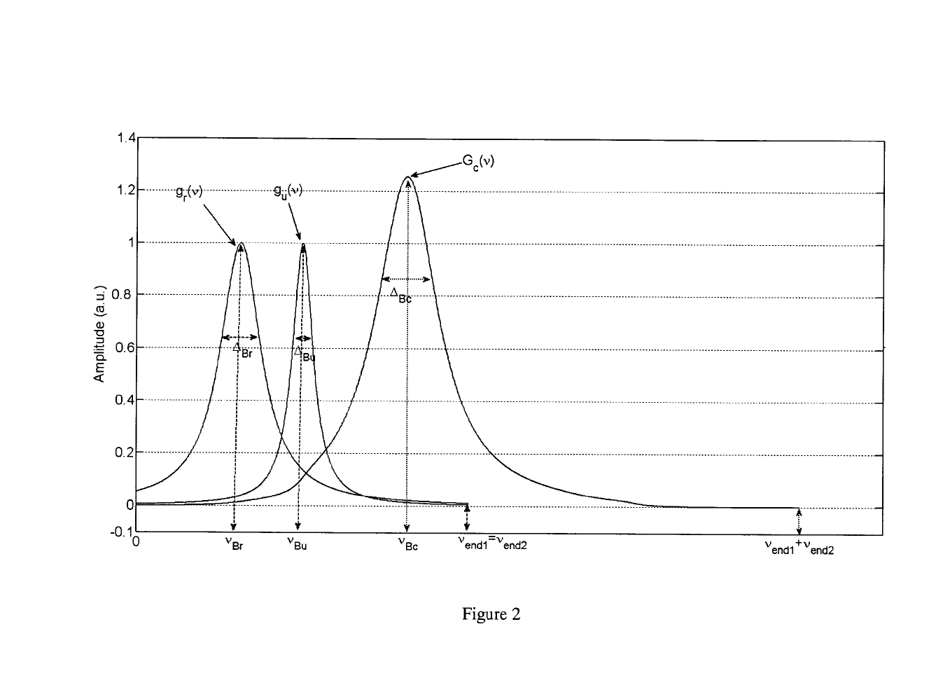

The bandwidth of G′_{c}(ν) is equal to the summation of bandwidths of the underlying curves and the central frequency of G_{c}(ν) is equal to the summation of the central frequencies of the underlying curves. FIG. 2 depicts gᵣ(ν), gᵤ(ν) and G_{c}(ν) along with a graphic illustration of their parameters. In FIG. 2, the amplitude of G_{c}(ν) is reduced in scale by a factor of 50 in order to have all curves in the same figure.

Using gᵣ(ν) as a reference Lorentzian curve with the known ν_{B}_{ᵣ}, the central frequency of the unknown curve gᵤ(ν) can be calculated by finding ν_{B}_{_{c}} and then using equation (4).

Before discussing cross-correlation methods applied to noisy Lorentzian curves according to the present invention (also referred to herein generally as the “cross-correlation method”), the cross-correlation between a Lorentzian curve and white noise is analyzed below.

The cross correlation between an ideal Lorentzian curve gᵣ(ν) and white noise n(ν) results in a random signal N_{c}(ν):

N_{c}(ν)=gᵣ(ν)*n(ν) (5)

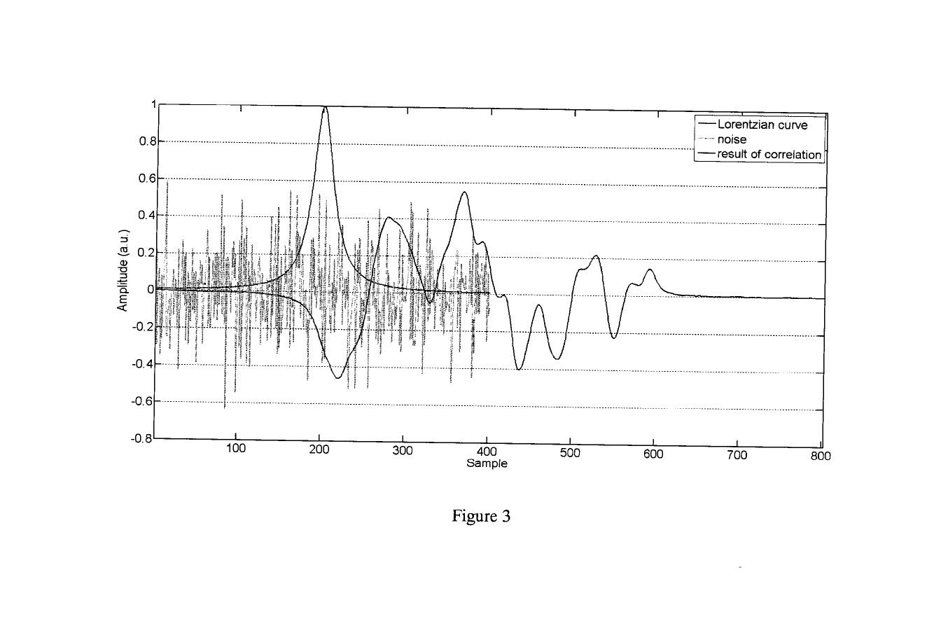

FIG. 3 shows N_{c}(ν) along with the Lorentzian curve and noise, where the noise variance is 0.2. In FIG. 3, the amplitude of the random signal N_{c}(ν) is almost same as the amplitude of noise n(ν).

The cross-correlation between ideal and noisy Lorentzian curves results in a curve where its shape is mainly determined by the signal, not the noise.

The cross correlation between a reference curve and a noisy Lorentzian curve can be explained as follows:

Expressing a noisy Lorentzian curve as summation of an ideal Lorentzian curve gₙ(ν) and additive white noise n(ν):

gₙ(ν)=gᵤ(ν)+n(ν) (6)

The cross-correlation between the reference and noisy Lorentzian curves results in the curve Gᵣₙ(ν):

Gᵣₙ(ν)=gᵣ(ν)* gₙ(ν)=gᵣ(ν)*[gᵤ(ν)+n(ν)]=gᵣ(ν)*g(ν)+gᵣ(ν)*n(ν)=G_{c}(ν)+N_{c}(ν) (7)

In equation (7), the term G_{c}(ν) is the signal resulting from the cross correlation between two ideal Lorentzian curves (see FIG. 2), and the term N_{c}(ν) is the signal resulting from the cross correlation between an ideal Lorentzian curve and white noise (see FIG. 3). The ratio between these two terms is proportional to the signal-to-noise ratio (“SNR”) of Gᵣₙ(ν) Comparison between the SNR of Gᵣₙ(ν) and SNR of gₙ(ν) demonstrates that Gᵣₙ(ν) is noisier than gₙ(ν). It can be also claimed that Gᵣₙ(ν) has a nearly ideal Lorentzian distribution around its peak and the noise is greatly eliminated in that area, as the reference Lorentzian curve is symmetric.

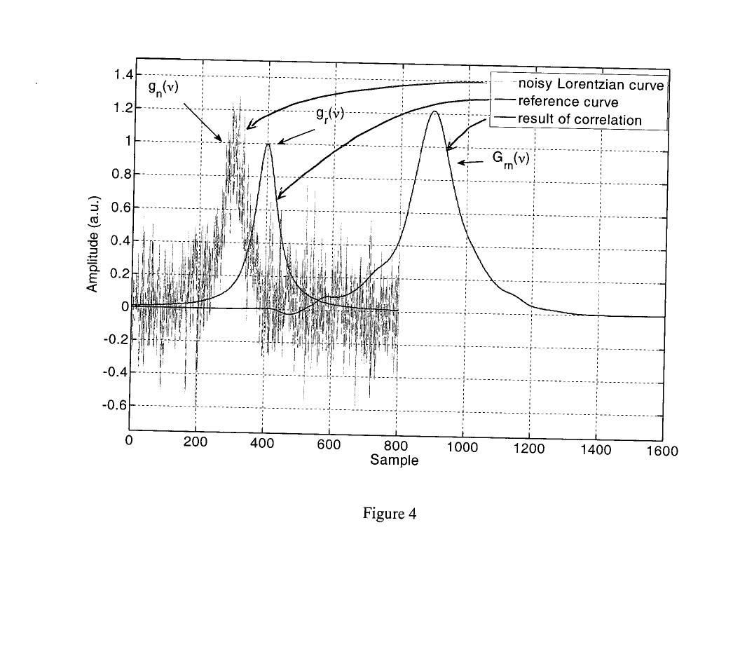

FIG. 4 shows a reference curve and a noisy Lorentzian curve along with the curve resulting from their cross-correlation. In FIG. 4, the amplitude of the resulting curve is again reduced in scale by a factor of 50 in order to have all curves in the same figure.

Assuming that the central frequency of the reference curve ν_{B}_{ᵣ} is known, the central frequency of the noisy Lorentzian curve ν_{B}_{ᵤ} can be accurately estimated based on equation (4) by finding the frequency of the maximum (the central frequency ν_{B}_{_{c}}) in the resulting curve.

In this way, the central frequency of a noisy Lorentzian curve is estimated using a method based on the cross-correlation technique (hereafter this method is called the correlation-based method).

In contrast to prior art curve fitting methods, the correlation-based method is free from the initial setting of fitting parameters. The specification of the reference Lorentzian curve is constant (unchanged) during experiments.

In addition, the computational complexity of the correlation-based method is on the order of O(2N) for a dataset of N points while the simplest curve fitting methods have a computational complexity on the order of O(rN²), where r is the number of iteration in curve fitting methods.

A reference Lorentzian curve is generally defined as follows: The central frequency ν_{B}_{ᵣ} is set to the middle frequency of the frequency range (frequency scanning range), the bandwidth Δν_{B}_{ᵣ} is set based on the type of the fiber used in experiments, and g_{B}_{ᵣ} is always normalized to 1.

Simulations

Simulations of correlation-based methods according to one or more embodiments of the present invention are compared with the curve fitting method based on the LMA. The LMA was selected as it is the most efficient least square error algorithm and the most common method used in optical fiber sensors to estimate BFSs. The central frequency of noisy Lorentzian curves is estimated using the LMA and correlation-based methods according to one or more embodiments of the present invention. The robustness of both methods with respect to noise and initialization of fitting parameters is examined through simulations. Every simulation is repeated one thousand times to make the results independent of any particular observation. As a result, the average of estimated central frequencies and the average of absolute error between the estimated and expected central frequencies are presented.

The noisy Lorentzian curves are generated by adding different realizations of white noise to an ideal Lorentzian curve in all simulations. The ideal curve is distributed in a range of frequencies from 10.800 GHz to 11.200 GHz and has the specifications of g_{B}=1, ν_{B}=11.100 GHz, and Δν_{B}=40 MHz. The SNR of the noisy curves changes from 0 dB to ∞ dB in simulations.

The SNR is calculated based on:

$$SNR = \frac{{g}_{B}^{2}}{{σ}_{n}^{2}} \qquad ( 8 )$$

where gₙ is the peak gain and σₙ² is the variance of noise.

### Sensitivity to Noise

The sensitivity of the LMA and correlation-based methods to noise is analyzed in this test. The curve parameters are initialized by the same specifications as the ideal Lorentzian curve (p₁=g_{B}=1, p₂=ν_{B}=11.100 GHz, and p₂=Δν_{B}=40 MHz) in the LMA method. In the correlation-based method, the reference curve has the specifications of gₙ_{_{b}}=1, ν_{B}_{ᵣ}=11,000 GHz, and Δν_{B}_{ᵣ}=40 MHz.

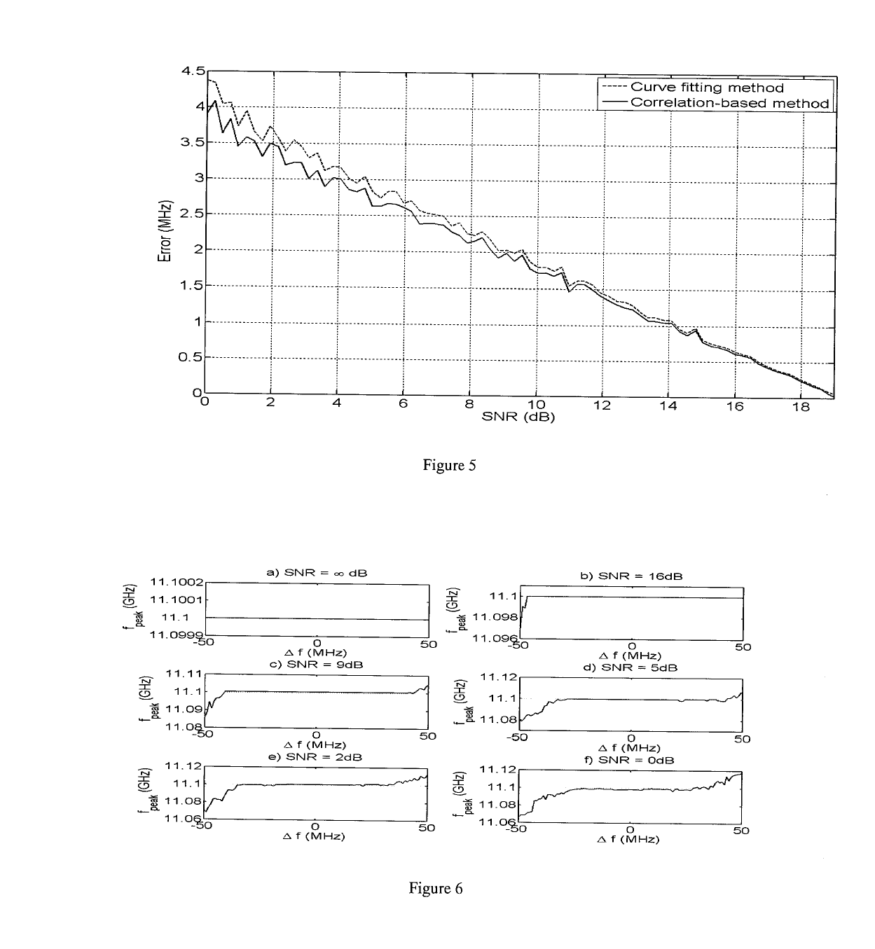

FIG. 5 shows the average of absolute error between the estimated and expected central frequencies versus the SNR. In FIG. 5, the dashed line is for the LMA method and solid line is for the correlation-based method. The results demonstrate that both methods obtain the same accuracy for the high SNR curves while the correlation-based method, according to one embodiment of the present invention, obtains a smaller error for low SNR curves.

### Sensitivity to the Central Frequency Parameter

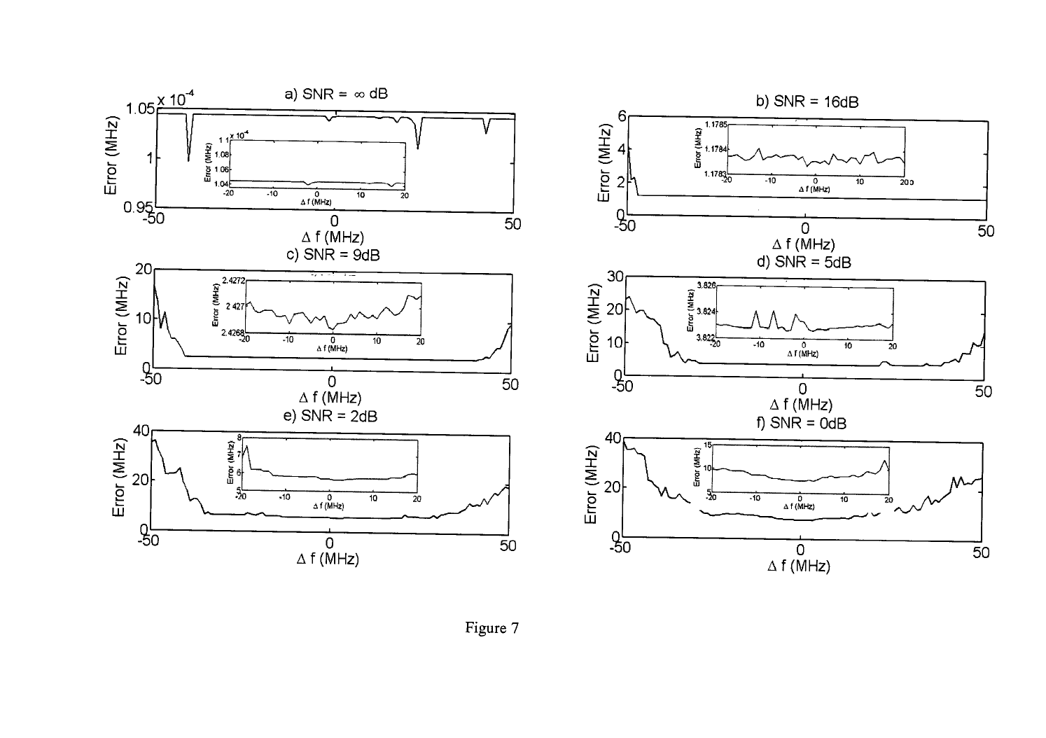

The LMA method provides accurate results when the central frequency parameter is appropriately initialized with a value close to the expected central frequency while the correlation-based method according to one embodiment of the present invention is free from this limitation. In this test, the central frequencies of noisy curves are estimated using the LMA method when the central frequency parameter changes in a range of −50 MHz to 50 MHz from the expected value. FIG. 6 and FIG. 7 show the estimated central frequencies and average of absolute error between the estimated and expected central frequencies at different SNRs.

Looking at FIG. 6 and FIG. 7, it is found that an error always exists between the estimated and expected central frequencies in the LMA method, even for high SNR curves. This error is inversely proportional to the SNR of curves. In addition to the error, the LMA method cannot fit into the noisy curves and estimate their central frequency, when the central frequency parameter is set too far off the expected frequency.

### Sensitivity to the Bandwidth Parameter

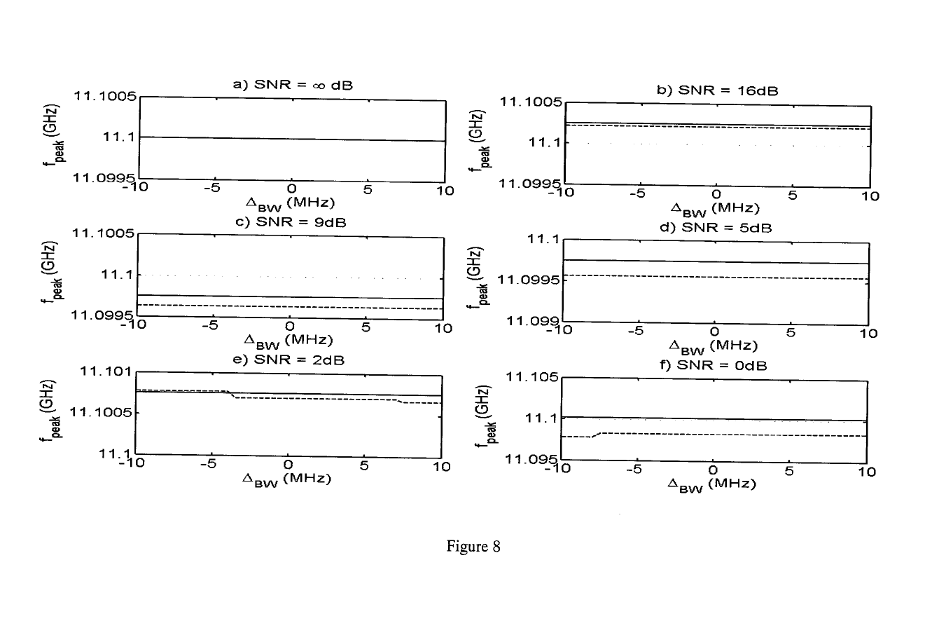

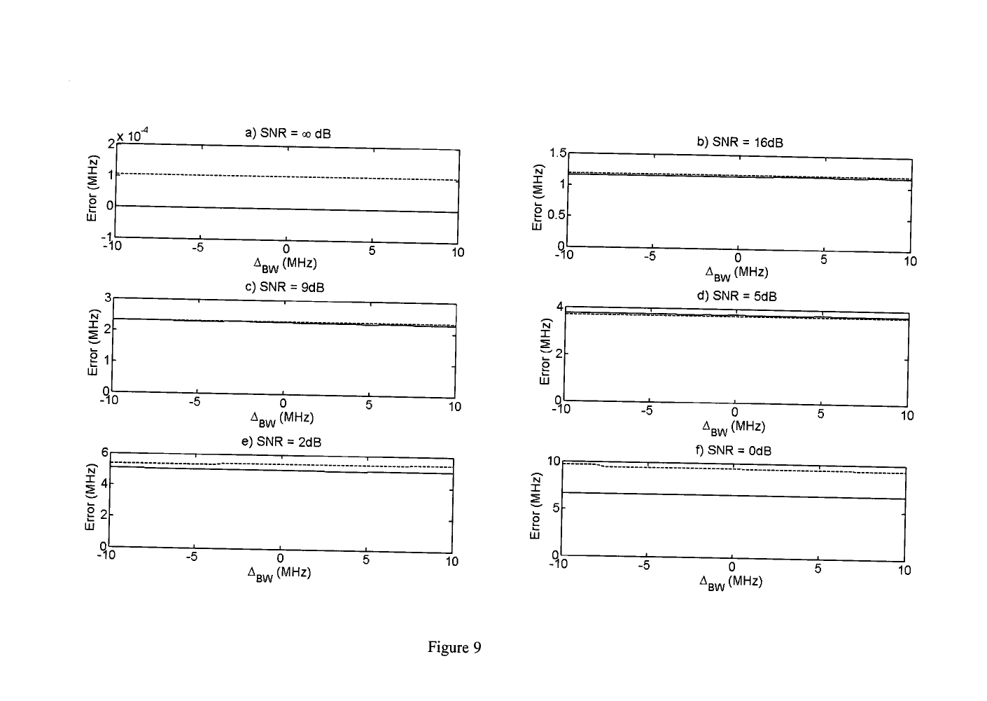

This test evaluates the accuracy of estimations using the LMA and correlation-based methods when the bandwidth parameter is initialized with a value different than the bandwidth of the curve under test. The bandwidth parameter is changed in a range of −10 MHz to 10 MHz from the expected one and central frequencies and the average of absolute error between the estimated and expected central frequencies are calculated. In the correlation-based method, the bandwidth of the reference Lorentzian curve is assumed as bandwidth parameter. FIG. 8 and FIG. 9 show the estimated central frequencies and error, respectively. In FIG. 8, the dashed line is for the LMA method and the solid line is for the correlation-based method. In FIG. 9, the dashed line is for the LMA and the solid line is for the correlation-based method.

The results of this test indicate that the correlation-based method is less sensitive than the LMA method to the wrong initialization of the bandwidth parameter. It is important to know that the central frequency parameter was initialized with the expected central frequency (11.100 GHz) in the LMA while the correlation-based method is free from this setting and the central frequency of the reference curve was located at 11 GHz.

### Application of the LMA and Correlation-Based Methods in BOTDA Sensors

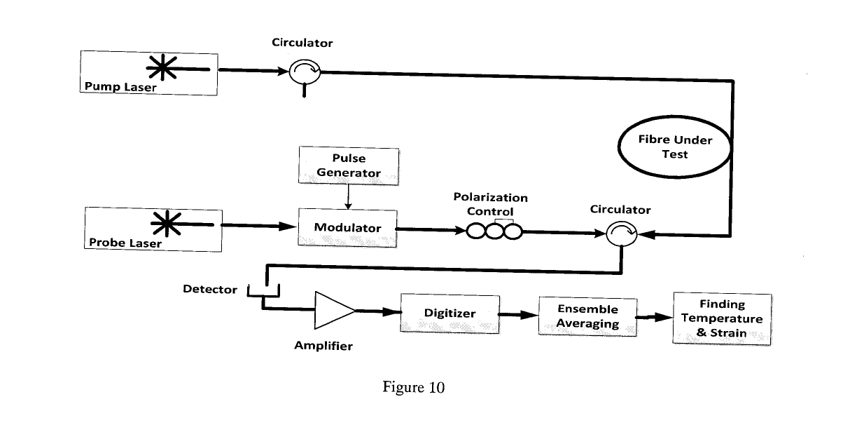

In one example, a BODTA system, similar to that presented in [12] was used to measure temperature distributed along a fiber. The hardware setup for this example is shown in FIG. 10.

In the setup of FIG. 10, two lasers operate at a nominal wavelength of 1550 nm. A 10 ns pulse, which corresponds to an approximate spatial resolution of 1 meter in the optical fiber, is used for this test. The optical fiber is excited with the laser frequency difference in the range of 10.880 GHz to 11.120 GHz with frequency steps of 4 MHz. Brillouin interaction is recorded through a detector monitoring the CW beam and then is sampled using a digitizer operating at the frequency of 1 GSPS.

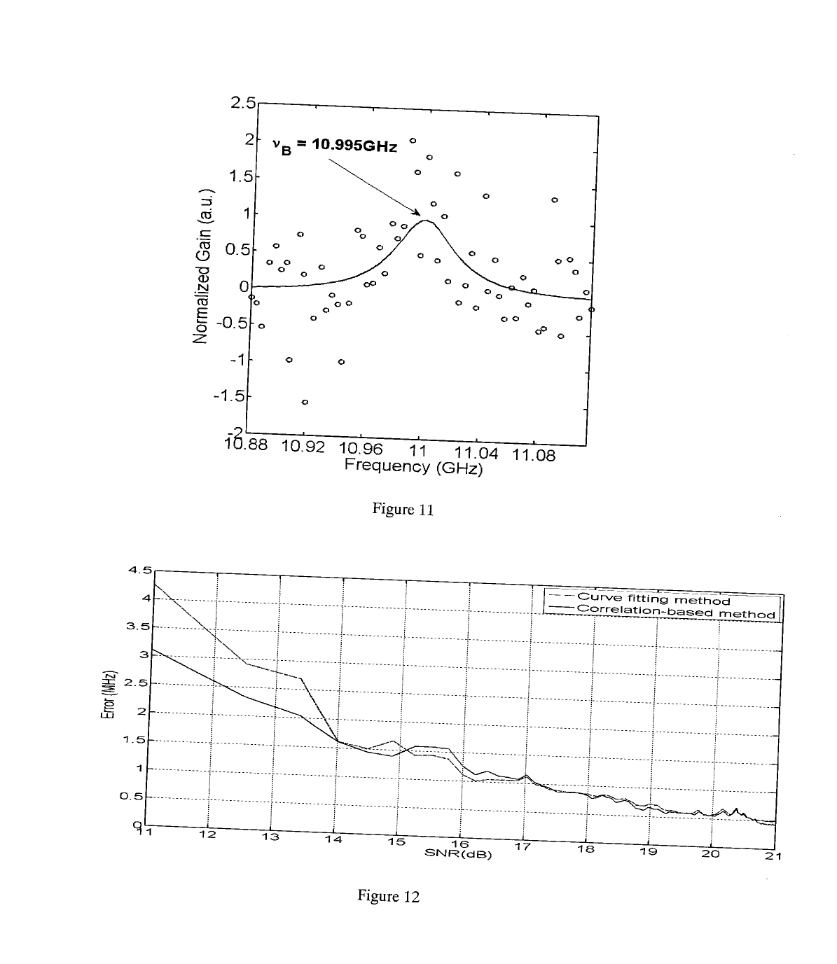

The fiber under test is maintained at a constant temperature of 22° C. as the test is performed. This temperature corresponds to a BFS of 10.995 GHz for all point along the fiber. FIG. 11 shows the spectrum at a point along the fiber and the Lorentzian curve expected to fit into the spectrum. The spectrum is very noisy and its SNR can be quantified based on the standard formula presented in [6]. In this formula, the SNR is defined as

$$SNR = \frac{{S}^{2}}{{N}^{2}} = \frac{{( g ( {v}_{B} ) )}^{2}}{{N}^{2}} = \frac{{g}_{B}^{2}}{{N}^{2}} \qquad ( 9 )$$

where N is the noise defined as the residual after subtracting the expected (fitted) curve from the noisy BGS. The calculation of SNR shows that the spectrum has an SNR of 3 dB.

In general, spectra acquired from measurements in BOTDA sensors are very noisy and it is nearly impossible to estimate an accurate BFS from them. Typically, numerous spectra are collected for each point along the fiber and are averaged to increase the SNR. The averaged spectra are fitted by Lorentzian curves to estimate the BFS for each point along the fiber. The accuracy of BFS depends on the method used for the estimation. More robust method with respect to noise and initial settings provides more accurate estimation.

The frequency step of 4 MHz limits the resolution of results obtained using the correlation-based method to this magnitude. To decrease the resolution to an acceptable value, the acquired spectra are up-sampled by an interpolation factor of L. The up-sampling is performed by adding L-1 zeros between each sample of data and then filtering data using a low-pass filter. A Kaiser window is used to filter out interpolated data as this window can be adjusted to have minimum aliasing.

### Experimental Tests

Unlike the simulated noisy curves, spectra acquired from actual BOTDA sensors have distortions besides noise. The central frequency of those spectra is estimated using the LMA and correlation-based methods and their performance versus noise and initialization of fitting parameters is evaluated.

In applications of the LMA method in BOTDA sensors, the fitting parameters are initialized based on the underlying noisy spectrum as follows: The central frequency parameter is set by the frequency of the maximum in the noisy spectrum; the difference between the maximum and minimum values in the noisy spectrum determines the gain parameter; and the bandwidth parameter is initialized by the value equal to twice of the difference between the frequency of the maximum and the frequency of the mean in the noisy spectrum. However, only one of those fitting parameters is changed in each experiment to emphasize the effect of its changes on the results of estimation of central frequencies.

In all experiments in this section, the length of fiber is 500 m and the SNR of spectra is changed from 11 dB to 21 dB by adjusting the number of spectra used for ensemble averaging. The interpolation factor is equal to 16, which causes a resolution of 0.25 MHz in results. It is also expected that all points along the fiber have the same central frequency of 10.995 GHz and the same bandwidth of 40 MHz, as the fiber under test is maintained at a constant temperature.

### Sensitivity of Noise

The central frequency of spectra is estimated using both methods at different levels of SNR and the average of absolute error between the estimated and expected central frequencies is calculated. For this test, the central frequency parameter is initialized with the expected values (10.995 GHz) in the LMA method while the central frequency of the reference curve is set by the middle frequency of the scanning range (11 GHz) in the correlation-based method. The bandwidth parameter is 40 MHz in both methods. FIG. 12 shows the error versus SNR as an evidence of sensitivity of methods to noise. In FIG. 12, the dashed line is for the LMA and the solid line is for the correlation-based method.

FIG. 12 reflects that both methods provide the same accuracy when the SNR is high but the correlation-based method provides more accurate results than the LMA method when the SNR is low.

### Sensitivity to the Central Frequency Parameter

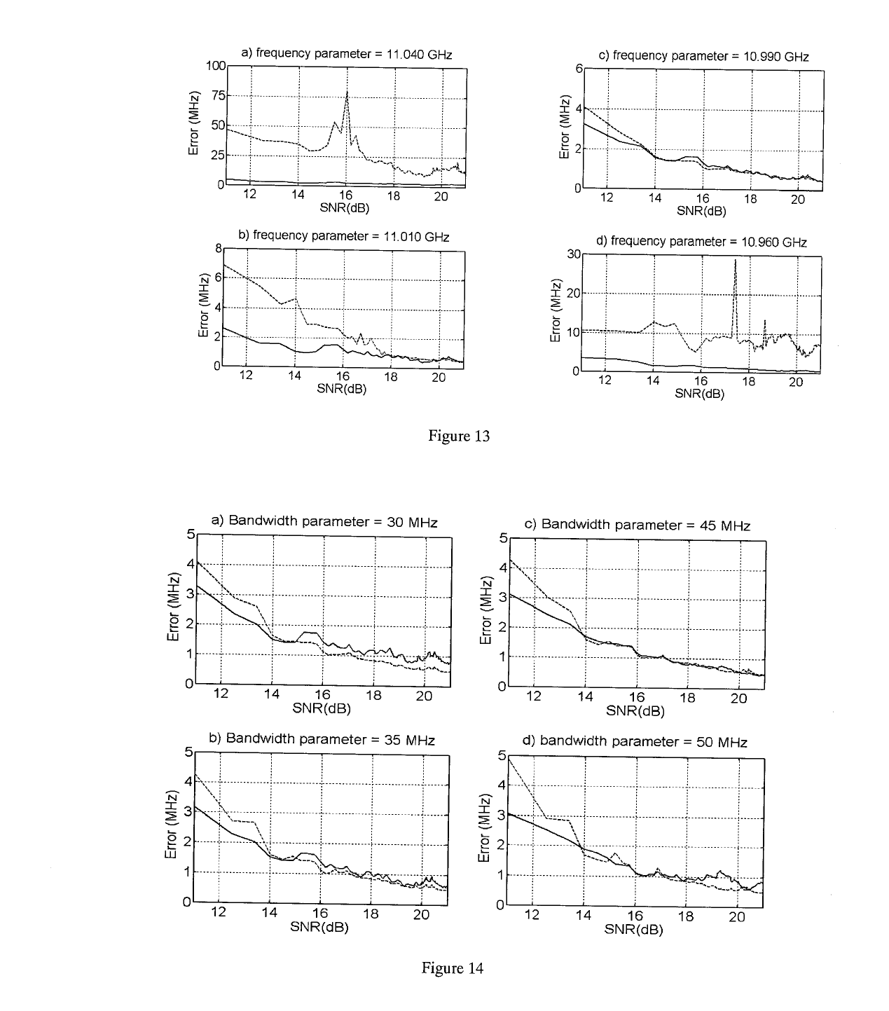

In this test, the LMA and correlation-based methods estimate the central frequency of all points along the fiber with respect to different initializations of the central frequency parameter. FIG. 13 shows the average of absolute error between estimated and expected central frequencies versus the SNR when the central frequency parameter is initialized to 11.040 GHz, 11.010 GHz, 10.990 GHz, and 10.960 GHz. In FIG. 13, the dashed line is for the LMA method and the solid line is for the correlation-based method. Since the expected central frequencies have a fixed value of 10.995 GHz in this test, the central frequency of the reference curve is changed to reflect the sensitivity of the correlation-based method to the initializations of the central frequency parameter.

The results of this test demonstrate that the correlation-based method is nearly independent of changes in the central frequency parameter. It provides almost the same error for all selections of this parameter. On the other hand, the results indicate that the good guess of central frequency is a prerequisite for the LMA method.

### Sensitivity to the Bandwidth Parameter

In this test, the LMA and correlation-based method estimate the central frequency for all points along the fiber regarding to different initializations of the bandwidth parameter. FIG. 14 shows the average of absolute error between estimated and expected frequencies versus SNR when the bandwidth parameter is initialized to 30 MHz, 35 MHz, 45 MHz, and 50 MHz in both methods. In FIG. 14, the dashed line is for the LMA method and the solid line is for the correlation-based method.

Looking at FIG. 14, it is found that the correlation-based method has a smaller error than the LMA method for the low SNR spectra while it has a larger or comparable error for the high SNR spectra. In the correlation-based method, the maximum increment in the level of errors caused by the initial setting of bandwidth parameter is 0.5 MHz while it is close to 1 MHz in the LMA method.

It is good to know that the central frequency parameter was initialized with the expected values (10.995 GHz) in the LMA method while it was set 11 GHz in the correlation-based method.

### Effects of Deviation in the Shape of Spectra on Accuracy

In some applications, a Lorentzian distribution would not completely describe the Brillouin gain spectrum acquired from BOTDA sensors because large bandwidth increases near the phonon lifetime significantly change the shape of the spectrum [5], [15]. As a result, the pseudo-Voigt profile was proposed to handle such situations [1]. The pseudo-Voigt profile represents a combination between the Lorentzian and Gaussian profiles and is expressed as:

$$g ( v ) = δ \frac{{g}_{B}}{1 + 4 {( \frac{v - {v}_{B}}{Δ {v}_{B}} )}^{2}} + ( 1 - δ ) {e}^{( - 4 ln 2 {( \frac{v - {v}_{B}}{Δ {v}_{B}} )}^{2} )} \qquad ( 10 )$$

where δ is the pseudo-Voigt shape factor (fully Lorentzian: δ=1, fully Gaussian: δ=0) determining the shape of spectra.

As the worst possible situation the central frequency of spectra were estimated having a Gaussian distribution by fitting a Lorentzian curve on them in the LMA method or using a reference curve having a Lorentzian distribution in the correlated-based method. For this test, an ideal Gaussian curve with the specifications of g_{B}=1, ν_{B}=11.000 GHz, and Δν_{B}=40 MHz is contaminated with different realizations of white noise to have an SNR changing from 0 dB to 19 dB.

The curve parameters are initialized by the same specifications as the ideal Gaussian curve (p₁=g_{B}=1, p₂=ν_{B}=11.000 GHz, and p₃=Δν_{B}=40 MHz) in the LMA. In the correlation-based method, the reference curve has the specifications of g_{B}=1, ν_{B}_{ᵣ}=11,000 GHz, and Δν_{B}_{ᵣ}=40 MHz.

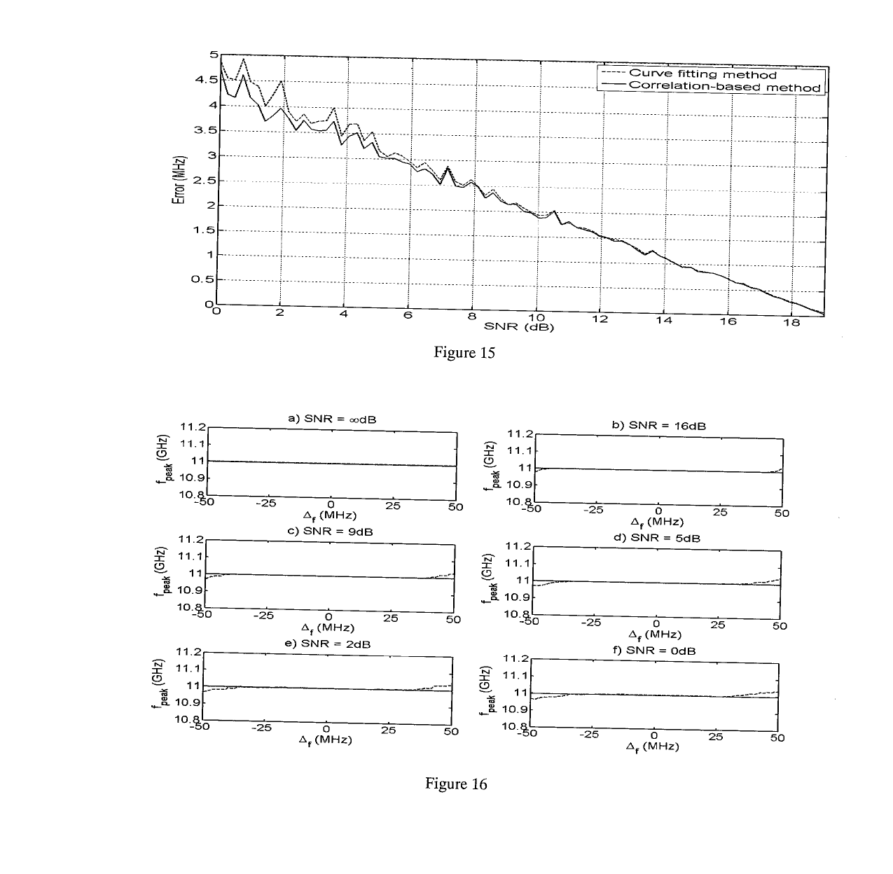

FIG. 15 shows the average of absolute error between the estimated and expected central frequencies versus the SNR. In FIG. 15, the dashed line is for the LMA and the solid line is for the correlation-based method. Looking at FIG. 15, it is found that both methods obtain the same accuracy for the high SNR curves while the correlation-based method provides smaller errors for low SNR curves.

In the same way, the central frequency of Gaussian curves is estimated at different SNR when the central frequency parameter changes in the range of −50 MHz to 50 MHz. FIG. 16 shows the results where the error obtained with the LMA method becomes larger when the central frequency parameter deviates from the expected value. In FIG. 16, the dashed line is for the LMA method and the solid line is for the correlation-based method.

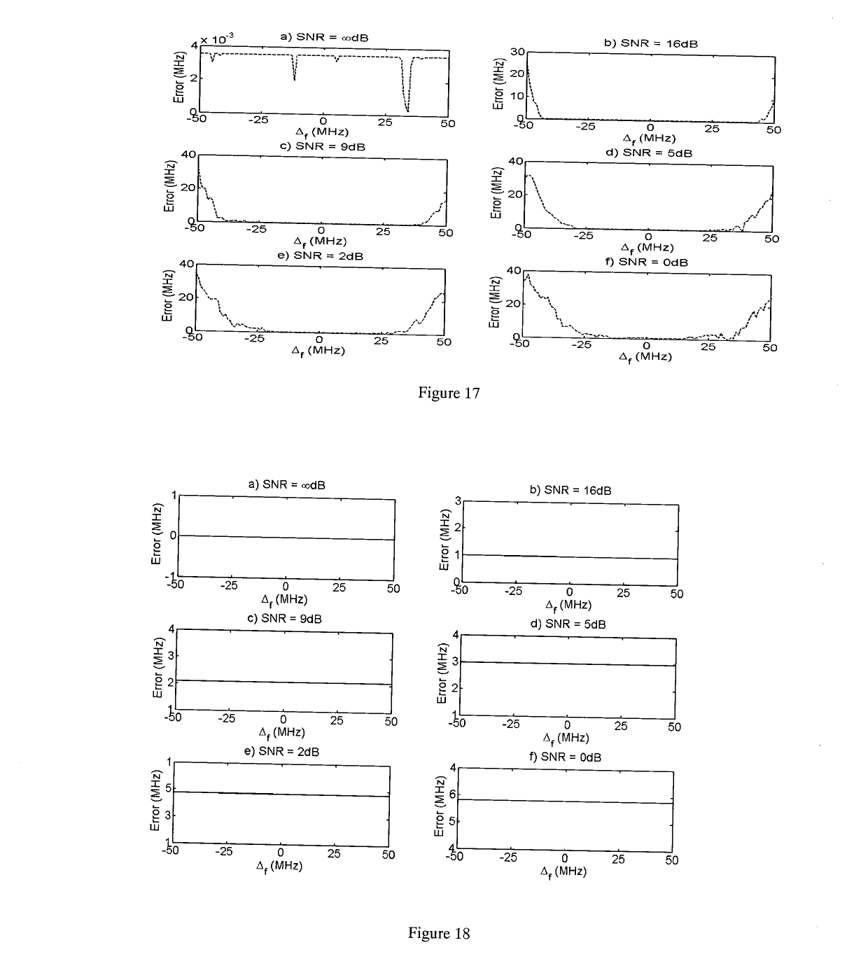

The error between the estimated and expected central frequencies is calculated and shown in FIG. 17 and FIG. 18, respectively. The results demonstrate that the error increases in the LMA by turning away from the expected central frequency (11 GHz) while it is constant in the correlation-based method. In the worst case, the error is about 5.7 MHz in the correlation-based method while it is about 38 MHz in the LMA.

The results also demonstrate that the LMA method estimates the central frequency accurately when its parameter is initialized with a value very close to the actual value. For example, at an SNR of 16 dB, the error is smaller than 2.8 MHz for the central frequency parameters in the range of −20 MHz to 20 MHz from the expected one. On the other hand, at an SNR of 16 dB, the correlation-based method provides a fixed error of approximately 1 MHz that the level of noise in spectra generated this error.

Methods of the present invention can be used to process measurements obtained by an SBS-Sensor. The methods of the present invention can be carried out using a microprocessor as part of an SBS-Sensor. One skilled in the art would know how to program a microprocessor or configure hardware such as an integrated circuit (for example a field-programmable gate array (FPGA) to perform the necessary steps described in this specification. In one embodiment, in the BOTDA system of FIG. 10, a microprocessor programmed with a method of the present invention or an integrated circuit configured to carry out a method according to the present invention can be located downstream of the Digitizer and used to process ensemble averaged measurements to output adjusted temperature and strain measurements.

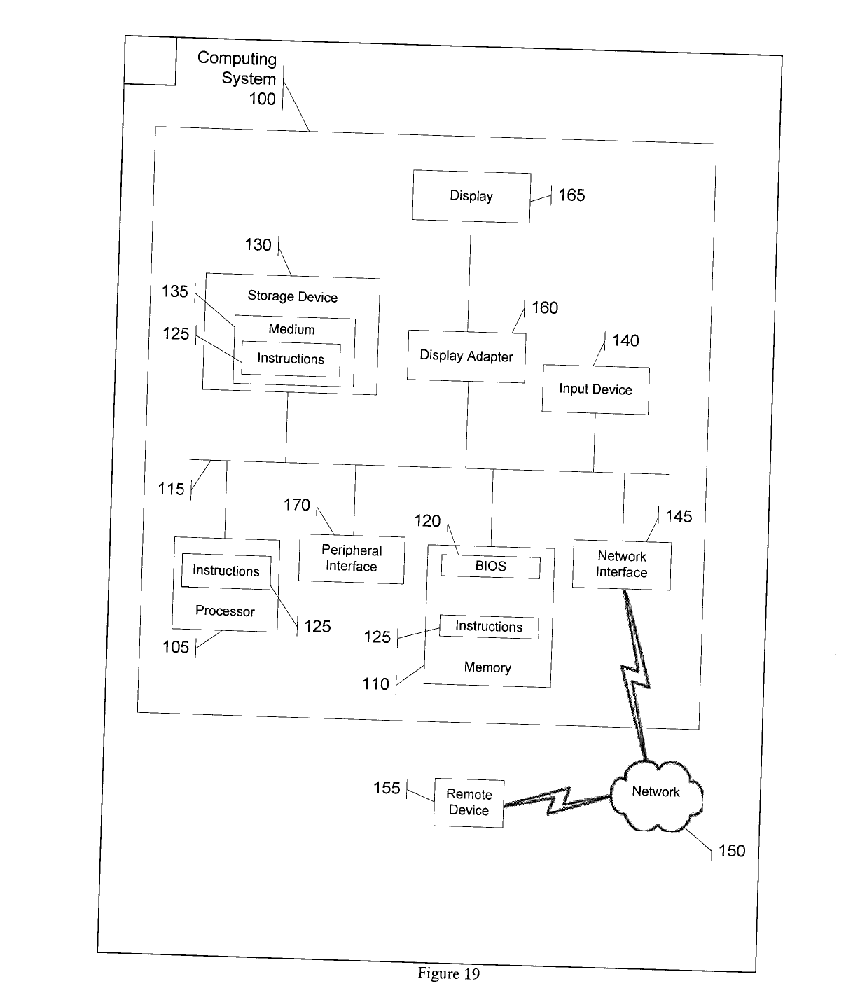

A computing system, such as a general purpose computing system or device, may be used to implement embodiments of the present invention wherein within the computing system, there is a set of instructions for causing the computing system or device to perform or execute any one or more of the aspects and/or methodologies of the present disclosure. It is also contemplated that multiple computing systems or devices may be utilized to implement a specially configured set of instructions for causing the device to perform any one or more of the aspects, functionalities, and/or methodologies of the present disclosure. FIG. 19 illustrates a diagrammatic representation of one embodiment of a computing system in the exemplary form of a computer system 100 which includes a processor 105 and memory 110 that communicate with each other, and with other components, via a bus 115. Bus 115 may include any of several types of bus structures including, but not limited to, a memory bus, a memory controller, a peripheral bus, a local bus, and any combinations thereof, using any of a variety of bus architectures.

Memory 110 may include various components (e.g., machine readable media) including, but not limited to, a random access memory component (e.g, a static RAM “SRAM”, a dynamic RAM “DRAM”, etc.), a read only component, and any combinations thereof. In one example, a basic input/output system 120 (BIOS), including basic routines that help to transfer information between elements within computer system 100, such as during start-up, may be stored in memory 110. Memory 110 may also include (e.g., stored on one or more machine-readable media) instructions (e.g., software) 125 embodying any one or more of the aspects and/or methodologies of the present disclosure. In another example, memory 110 may further include any number of program modules including, but not limited to, an operating system, one or more application programs, other program modules, program data, and any combinations thereof.

Computer system 100 may also include a storage device 130. Examples of a storage device (e.g., storage device 130) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 130 may be connected to bus 115 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 130 (or one or more components thereof) may be removably interfaced with computer system 100 (e.g., via an external port connector (not shown)). Particularly, storage device 130 and an associated machine-readable medium 135 may provide non-volatile and/or volatile storage of machine-readable instructions 125, data structures, program modules, and/or other data for computer system 100. In one example, software 125 may reside, completely or partially, within machine-readable medium 135. In another example, software 125 may reside, completely or partially, within processor 105.

Computer system 100 may also include an input device 140. In one example, a user of computer system 100 may enter commands and/or other information into computer system 100 via input device 140. Examples of an input device 140 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touch screen, and any combinations thereof. Input device 140 may be interfaced to bus 115 via any of a variety of interfaces (not shown) including, but not limited to, a serial interface, a parallel interface, a game port, a USB interface, a FIREWIRE interface, a direct interface to bus 115, and any combinations thereof. Input device may include a touch screen interface that may be a part of or separate from display 165, discussed further below.

A user may also input commands and/or other information to computer system 100 via storage device 130 (e.g., a removable disk drive, a flash drive, etc.) and/or a network interface device 145. A network interface device, such as network interface device 145 may be utilized for connecting computer system 100 to one or more of a variety of networks, such as network 150, and one or more remote devices 155 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 150, may employ a wired and/or a wireless mode of communication. In general, any network topology may be used. Information (e.g., data, software 125, etc.) may be communicated to and/or from computer system 100 via network interface device 145.

Computer system 100 may further include a video display adapter 160 for communicating a displayable image to a display device, such as display device 165. Examples of a display device include, but are not limited to, a liquid crystal display (LCD), a cathode ray tube (CRT), a plasma display, a light emitting diode (LED) display, and any combinations thereof. In addition to a display device, a computer system 100 may include one or more other peripheral output devices including, but not limited to, an audio speaker, a printer, and any combinations thereof. Such peripheral output devices may be connected to bus 115 via a peripheral interface 170. Examples of a peripheral interface include, but are not limited to, a serial port, a USB connection, a FIREWIRE connection, a parallel connection, and any combinations thereof.

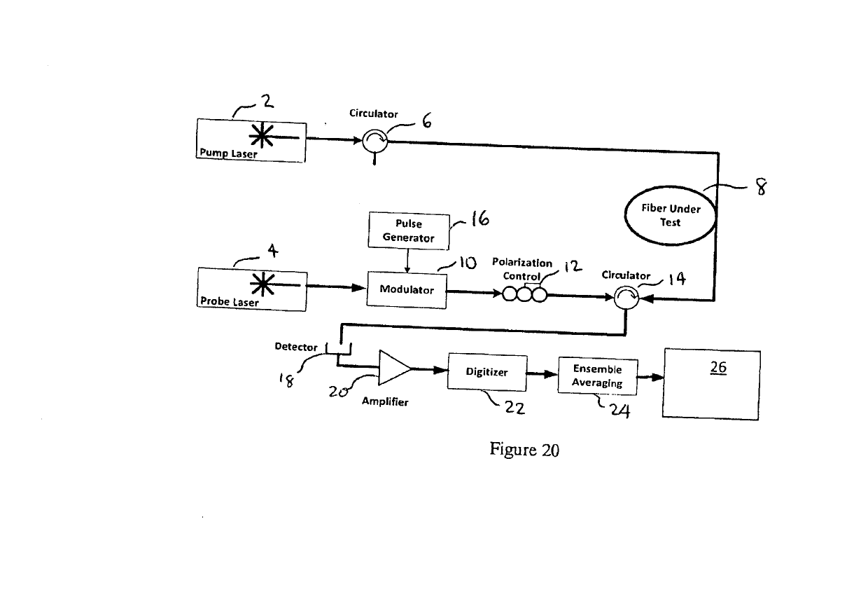

Methods which embody the principles of the present invention, in one or more embodiments, can be integrated in optical systems such as SBS-based optical fiber sensors, for example a BODTA sensor system of the type illustrated in FIG. 20, as a BFS calculation module 26 after the ensemble averaging module. The Brillouin analysis sensor system illustrated in FIG. 20 includes a pump laser 2 and a probe laser 4; a first circulator 6 and a sensing fiber 8 the pump laser 2 connected to the first circulator 6 and the first circulator 6 is connected to the sensing fiber 8; a modulator 10, polarization control 12 and a second circulator 14 wherein the probe laser 4 is connected to the modulator 10, the modulator 10 is connected to the polarization control 12, the polarization control 12 is connected to the second circulator 14, and the second circulator 14 is connected to the sensing fiber 8; a pulse generator 16; wherein the pulse generator 16 is connected to the modulator 10; a detector 18, amplifier 20, digitizer 22, ensemble averaging module 24, BFS calculation module 26 wherein the second circulator 14 is connected to the detector 18, the detector 18 is connected to the amplifier 20, the amplifier 20 is connected to the digitizer 22, the digitizer 22 is connected to the ensemble averaging module 24 and the ensemble averaging module 24 is connected to the the BFS calculation module 26 may also be integrated in another suitable location in the BODTA system, illustrated in FIG. 20, before or after the ensemble filter and may also take another suitable form such as a denoising apparatus or denoising module which may take the form of a computer system programmed to carry out a denoising method according to an embodiment of the present invention.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertain, and those aspects and modifications are within the scope of the invention.

### REFERENCES

[1] A. Yariv, “Optical electronics,” CBS College Publishing, New York, US, 1985.
[2] M. Nikles, L. Thevenaz, P. A. Robert, “Brillouin gain spectrum characterization in single-mode optical fibers,” J. Lightw. Technol., vol. 15, no. 10, pp. 1842-1851, October 1997.
[3] A. L. Gaeta and R. W. Boyd, “Stochastic dynamics of stimulated Brillouin scattering in an optical fiber,” Phys. Rev. A, vol. 44, pp. 3205-3209, 1991.
[4] X. Bao et al., “Characterization of the Brillouin-loss spectrum of single-mode fibers by use of very short (<10-ns) pulses,” Optics Lett., vol. 24, no. 8, pp. 510-512, 1999.
[5] Z. Liu et al., “Brillouin scattering based distributed fiber optic temperature sensing for fire detection,” 7th Int. Symp. on Fire Safety, Worcester, USA, 2002, pp.221-232.
[6] J. Dhliwayo, D. J. Webb and C. N. Pannell, “Statistical analysis of temperature measurement errors in a Brillouin scattering based distributed temperature sensor,” Proc. SPIE, vol. 2838, 1996, pp. 276-286.
[7] K. Madsen, H. B. Nielsen, and 0. Tingleff, “Methods for Non-linear least squares problems,” informatics and mathematical modeling technical university of Denmark, 2″ edition, April 2004.
[8] G. Seber and C. J. Wild, “Nonlinear regression,” Hoboken, N.J., Wiley-Interscience, 2003.
[9] M. DeMerchant et al. “Automated system for distributed sensing,” Proc. SPIE, vol. 3330, San Diego, Calif., USA, 1998, pp. 315-332.
[10] K. Levenberg, “A method for the solution of certain non-linear problems in least squares,”

Quarterly of Applied Mathematics, vol. 2, no. 2, pp. 164-168, July 1944.
[11] R. Fletcher, “A modified Marquardt subroutine for nonlinear least squares,” Rpt. AERE-R 6799, Harwell, 1971.
[12] A. W. Brown, B. G. Colpitts and K. Brown, “Dark-pulse Brillouin optical time domain sensor with 20-mm spatial resolution,” J. Lightw. Technol., vol. 25, no. 1, pp. 381-386, January 2007.
[13] F. Ravet, “Pipeline buckling detection by the distributed Brillouin sensor,” Sensing Issues in Civil Structural Health Monitoring, 2005, Springer Netherlands, pp. 515-524.
[14] C. Li and Y. Li, “Fitting of Brillouin spectrum based on LabVIEW,” 5^{th} International

Conference on Wireless Communications, Networking and Mobile Computing, September 2009, pp. 1-4.
[15] R. Boyd, K. RzaÕewski, P. Narum, “Noise initiation of stimulated Brillouin scattering,” Physical Review A, vol. 42, pp. 5514-5521, 1990.

We claim:

1. A method of determining a Brillouin frequency shift from one or more Brillouin gain measurements in an optical fiber comprising:
providing an ideal Lorentzian curve with a known Brillouin frequency shift;
providing a noisy Lorentzian curve; and
cross correlating the ideal Lorentzian curve with the noisy Lorentzian curve wherein the product of the cross correlation is a third Lorentzian curve.

2. The method of claim 1 wherein the shape of the third Lorentzian curve is substantially determined by the one or more Brillouin gain measurements.

3. The method of claim 1 wherein the Lorentzian curves are Gaussian curves.

4. A method of determining a parameter of an optical fiber comprising:
providing an optical fiber sensor system;
providing an optical fiber connected to the optical fiber sensor system;
using the optical fiber sensor system to excite a Brillouin interaction at a point along the optical fiber;
acquiring one or more discreet measurements of the Brillouin gain spectrum from the interaction, the Brillouin gain spectrum comprising the parameter's Brillouin frequency shift, bandwidth and peak gain;
modeling the Brillouin gain spectrum with a Lorentzian curve comprising a central frequency;
estimating the central frequency of the Lorentzian curve;
providing a reference Lorentzian curve with a known Brillouin frequency shift;
providing a noisy Lorentzian curve;
cross correlating the reference Lorentzian curve with the noisy Lorentzian curve wherein the product of the cross correlation is a third Lorentzian curve;
determining the central frequency of the third Lorentzian curve;
using the central frequency of the third Lorentzian curve to estimate the central frequency of the noisy Lorentzian curve;
acquiring a temperature coefficient and a strain coefficient of the optical fiber; and
using the estimated central frequency of the noisy Lorentzian curve and the temperature and strain coefficients to determine a parameter of the optical fiber, the parameter selected from the group consisting of temperature and strain.

5. The method of claim 4 wherein the optical fiber sensor is an SBS-based sensor.

6. The method of claim 5 wherein the SBS-based sensor comprises a probe laser and a pump laser.

7. The method of claim 6 wherein the step of exciting a Brillouin interaction at a point along the optical fiber comprises generating a pulsed probe beam using the probe laser and generating a continuous wave pump beam using the pump laser.

8. The method of claim 5 wherein the SBS-based sensor is a BOTDA sensor.

9. The method of claim 4 further comprising representing the one or more discreet measurements as data points and wherein the step of modeling the Brillouin gain spectrum with a Lorentzian curve comprising fitting a Lorentzian curve to the data points.

10. The method of claim 4 wherein the noisy Lorentzian curve comprises an ideal Lorentzian curve and noise in the one or more discreet measurements.

11. The method of claim 4 wherein the Lorentzian curves are Gaussian curves.

12. An optical fiber sensor system comprising:
a pump laser and a probe laser;
a first circulator and a sensing fiber;
the pump laser connected to the first circulator and the first circulator connected to the sensing fiber;
a modulator, polarization control and a second circulator wherein the probe laser is connected to the modulator, the modulator is connected to the polarization control, the polarization control is connected to the second circulator, and the second circulator is connected to the sensing fiber;
a pulse generator wherein the pulse generator is connected to the modulator;
a detector, amplifier, digitizer, ensemble averaging module, wherein the second circulator is connected to the detector, the detector is connected to the amplifier, the amplifier is connected to the digitizer, the digitizer is connected to the ensemble averaging module and the ensemble averaging module is connected to the BFS calculation module.

13. The sensor of claim 12 wherein the BFS calculation module determines a Brillouin frequency shift from one or more Brillouin gain measurements made by the sensor in an optical fiber connected to the sensor.

14. The sensor of claim 13 wherein with respect to a measurement, the BFS calculation module
provides an ideal Lorentzian curve with a known Brillouin frequency shift,
provides a noisy Lorentzian curve; and
cross correlates the ideal Lorentzian curve with the noisy Lorentzian curve wherein the product of the cross correlation is a third Lorentzian curve.
